(19) United States
(12) Patent Application Publication
(10) Pub. No.: US 2026/0097927 A1
(43) Pub. Date: Apr. 9, 2026

(54) CONNECTING PART FOR A HOLLOW GUIDE RAIL, GUIDE RAIL ASSEMBLY, ELEVATOR AND METHOD FOR ASSEMBLING A HOLLOW GUIDE RAIL

(71) Applicant: KONE Corporation, Helsinki (FI)

(72) Inventors: Marco Guglielmo, Helsinki (FI); Emil Aaltonen, Helsinki (FI); Marko Meriläinen, Helsinki (FI); Giovanni Hawkins, Helsinki (FI); Tomi Kapanen, Helsinki (FI); Petri Pukkila, Helsinki (FI); Jürgen Brucker, Helsinki (FI); Juha Pönkkä, Helsinki (FI); Mika Alvesalo, Helsinki (FI)

(73) Assignee: KONE Corporation, Helsinki (FI)

(21) Appl. No.: 19/417,019

(22) Filed: Dec. 11, 2025

Related U.S. Application Data
(63) Continuation of application No. PCT/FI2023/050347, filed on Jun. 12, 2023.

(51) Int. Cl. B66B 7/02; B66B 19/00

(52) U.S. Cl. CPC B66B 7/026; B66B 7/022; B66B 19/002

(57) ABSTRACT

The connecting part for connecting first and second T-shaped guide rail parts of a hollow guide rail of an elevator to each other includes first and second stem portions configured to contact sides of the stems of the guide rail parts, first and second arm portions configured to contact arms of the guide rail parts, the arm portions being configured to be attached to the respective arms by threaded fastening elements configured to be inserted through the arms of the guide rail parts and through the arm portions of the connecting part, and by threaded counterparts configured to be engaged with the threaded fastening elements, the connecting part being configured to deform as a result of the mutual tightening of the threaded fastening elements and the respective threaded counterparts and to exert a force on the inner surfaces of the guide rail parts.

### TECHNICAL FIELD OF THE INVENTION

The present invention relates to a connecting part for connecting a first guide rail part and a second guide rail part of a hollow guide rail of an elevator to each other, as defined in claim 1. The invention also concerns a guide rail assembly for an elevator, an elevator, and a method for assembling a hollow guide rail of an elevator.

### BACKGROUND OF THE INVENTION

Most elevators are provided with vertical guide rails, which are used for guiding an elevator car and/or a counterweight. Often the elevator is provided with own guides rail for both the elevator car and the counterweight. The guide rails run in the vertical direction from the bottom to the top of the shaft. Typically, each guide rail consists of several vertical segments. The guide rails are assembled by connecting those segments to each other on-site. A typical guide rail has a T-shaped cross-sectional profile. The arms of the profile are used for attaching the guide rail to the elevator shaft, usually via guide rail brackets. The stem of the profile forms a nose that functions as support surfaces for the elevator car or the counterweight. The guide rail segments may be hollow parts. Such hollow guide rail parts can be attached to each other by inserting into two successive guide rail parts a connecting part, which can be called as a fishplate. The ends of the guide rail parts are provided with holes and the fishplate is provided with corresponding holes. Bolts are inserted through the holes and washers and nuts are used for forming a bolt joint.

The guide rail parts are typically steel profiles. The fishplates can be extruded aluminum parts, which bring some disadvantages. For instance, there needs to be a loose fit between the fishplate and the guide rail parts to allow convenient assembly and to avoid problems caused by different thermal expansion coefficients of steel and aluminum. The loose fit can cause noise and premature wear of the sliding guide shoes of the counterweight or elevator car.

### SUMMARY OF THE INVENTION

An object of the present invention is to provide an improved connecting part for connecting a first guide rail part and a second guide rail part of a hollow guide rail of an elevator to each other, wherein each of said guide rail parts has a T-shaped cross-sectional profile comprising a stem, a first arm and a second arm. The characterizing features of the connecting part according to the invention are given in claim 1. Other objects of the invention are to provide an improved guide rail assembly for an elevator, an elevator, and a method for assembling a hollow guide rail of an elevator.

The connecting part according to the invention is made of sheet metal and has a first end that is configured to be inserted into the first guide rail part and a second end that is configured to be inserted into the second guide rail part. The connecting part comprises
a first stem portion configured to contact a first side of the stem of each of the guide rail parts,
a second stem portion configured to contact a second side of the stem of each of the guide rail parts,
a first arm portion configured to contact the first arm of each of the guide rail parts, and
a second arm portion configured to contact the second arm of each of the guide rail parts.

Each arm portion of the connecting part is configured to be attached to the respective arm of the first guide rail part and the second guide rail part by means of at least one threaded fastening element that is configured to be inserted through the arm of the guide rail part and through the arm portion of the connecting part and by means of a threaded counterpart that is configured to be engaged with the threaded fastening element.

The connecting part is configured to deform as a result of the mutual tightening of said threaded fastening elements and the respective threaded counterparts and to exert a force on the inner surfaces of the guide rail parts.

The connecting part according to the invention helps avoiding the problems of the prior art solutions. The connecting part is less expensive to manufacture than extruded aluminum parts. The connecting part is self-aligning in the joint and thus reduces the assembly time of the guide rails. The connecting part also increases the stiffness of the guide rail and provides better ride comfort for the elevator.

According to an embodiment of the invention, the connecting part is configured such that said deforming of the connecting part exerts a force on the inner surfaces of the first and second sides of the stems of the guide rail parts. The connecting part is configured such that the force exerted on the inner surfaces of the sides of the stems is small to avoid deformation of guide surfaces of the guide rail.

According to an embodiment of the invention, the connecting part is configured such that said deforming of the connecting part exerts a force on the inner surfaces of the tops of the stems of the guide rail parts. Also the force exerted on the inner surfaces of the tops of the stems should be relatively small to avoid deformation of the stem.

According to an embodiment of the invention, the connecting part is configured such that said deforming of the connecting part exerts a force on the inner surfaces of the arms of the guide rail parts on the sides that are opposite to the stems of the guide rail parts. The forces exerted on the inner surfaces of the arms can be slightly greater than the forces exerted on the inner surfaces of the stem. However, the forces should be small enough to avoid significant deformation of the guide rail parts.

According to an embodiment of the invention, as a result of the mutual tightening of each threaded fastening element and the respective threaded counterpart, the connecting part is configured to deform plastically around said threaded fastening element.

According to an embodiment of the invention, the connecting part is an open profile. Less force is needed for deforming an open profile than a closed profile. A connecting part with an open profile is thus easier to assemble and easier to configure such that deformation of the guide rail parts is avoided.

According to an embodiment of the invention, the connecting part is made of steel. By using connecting parts made of steel with guide rails that are made of steel, problems caused by different thermal expansion coefficients can be avoided.

The guide rail assembly according to the invention comprises
a first guide rail part and a second guide rail part, each of the guide rail parts being hollow parts having a T-shaped cross-sectional profile comprising a stem, a first arm and a second arm;
a connecting part defined above inserted into the first guide rail part and into the second guide rail part;
at least one threaded fastening element inserted through each arm of each of the first guide rail part and the second guide rail part and through the respective arm portion of the connecting part; and
a threaded counterpart for each threaded fastening element, the threaded counterpart being engaged with the respective threaded fastening element and tightened to deform the connecting part.

According to an embodiment of the invention, each arm of each guide rail part is provided with a first attachment hole arranged on the side opposite to the stem of the guide rail part and with a second attachment hole arranged on the side of the stem for receiving said threaded fastening element, and each of the first arm portion and the second arm portion of the connecting part is provided with an attachment hole that is configured to be aligned with the first attachment hole of the respective arm of the guide rail part and has a smaller diameter than the first attachment hole, and the threaded fastening element or the counterpart is provided with a flange surface that is configured to contact the connecting part around said attachment hole of the connecting part when the counterpart is tightened to deform the connecting part.

According to an embodiment of the invention, each threaded fastening element has a tapered head. This facilitates aligning of the attachment holes of the connecting part and the guide rail parts.

The elevator according to the invention comprises a guide rail assembly defined above.

According to an embodiment of the invention, the guide rail assembly is part of a guide rail of a counterweight of the elevator. Hollow guide rails are typically used for guiding counterweights, as the counterweight guide rails do not usually need to withstand forces exerted by safety gears.

The method according to the invention comprises the steps of
providing
   a first guide rail part and a second guide rail part, each of the guide rail parts being a hollow part having a T-shaped cross-sectional profile comprising a stem, a first arm and a second arm,
   a connecting part defined above,
   at least one threaded fastening element for each arm of each of the first guide rail part and the second guide rail part, configured to be inserted through the respective arm and through the respective arm portion of the connecting part, and
   a threaded counterpart for each threaded fastening element, the threaded counterpart being configured to be engaged with the threaded fastening element and tightened to deform the connecting part;
inserting a first end of the connecting part into the first guide rail part;
engaging a second end of the connecting part with the second guide rail part; and
attaching the first end of the connecting part to the first guide rail part by means of said threaded fastening elements and threaded counterparts; and
attaching the second guide rail part to the connecting part by means of said threaded fastening elements and threaded counterparts.

### BRIEF DESCRIPTION OF THE DRAWINGS

Embodiments of the invention are described below in more detail with reference to the accompanying drawings, in which

FIG. 1 shows schematically a simplified view of an elevator,

FIG. 2 shows parts of a guide rail assembly according to an embodiment of the invention,

FIG. 3 shows part of two guide rail parts connected to each other,

FIG. 4 shows a partly cross-sectional view of a guide rail assembly according to an embodiment of the invention,

FIG. 5 shows an end view of a guide rail assembly according to another embodiment of the invention,

FIG. 6 shows a cross-sectional view of a guide rail assembly according to an embodiment of the invention, and

FIG. 7 shows as a flow chart the method according to the invention.

### DETAILED DESCRIPTION OF EMBODIMENTS OF THE INVENTION

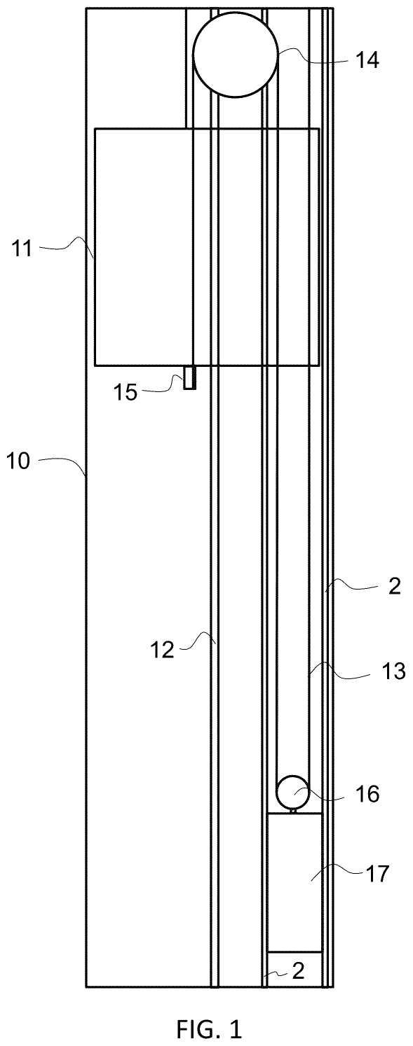

FIG. 1 shows a simplified schematic view of an elevator. The elevator comprises an elevator car 11 and a counterweight 17 which are configured to be moved in the vertical direction in an elevator shaft 10. For the sake of clarity, many parts of the elevator, such as end buffers for the elevator car 11 and the counterweight 17 have been omitted in FIG. 1. The elevator car 11 is connected to the counterweight 17 via a hoisting member 13. The hoisting member 13 can be, for example, a steel wire, a belt, such as a toothed belt or a flat belt, a carbon fiber rope or a coated rope. The elevator can comprise several hoisting members 13. The elevator car 11 and the counterweight 17 are connected to each other in such a way that they move to opposite directions in respect of each other. The elevator is further provided with a motor 14. The motor 14 is preferably an electric motor. The motor 14 drives a sheave (not shown). The sheave can be connected to the motor 14 either directly or via a gear. As the sheave rotates, the hoisting member 13 moves and the elevator car 11 and the counterweight 17 are moved. In the example of FIG. 1, each end of the hoisting member 13 is fixed to the upper end of the shaft 10. The elevator car 11 is provided with two pulleys, of which only one pulley 15 is shown in FIG. 1. In the example of FIG. 1, the pulleys are arranged below the elevator car 11. The hoisting member 13 is engaged with the pulleys, which are configured to rotate freely about a rotation axis. The counterweight 17 is provided with a pulley 16 which is engaged with the hoisting member 13. Also the pulley 16 of the counterweight 17 is configured to rotate freely about a rotation axis. The sheave, the pulleys 15, 16 and the hoisting member 13 form the roping system of the elevator.

It should be noted that FIG. 1 shows only an example of a roping system of an elevator, and the hoisting member 13 could be arranged in many alternative ways. For example, the elevator car 11 could be provided with a single pulley. The counterweight 17 could be provided with more than one pulleys. A first end of the hoisting member 13 could be attached to the elevator car 11 and a second end of the hoisting member 13 could be attached to the counterweight 17. The hoisting member 4 could be guided around the sheave of the motor 14 twice.

In the example of FIG. 1, the motor 14 is arranged in the shaft 10. The elevator is thus a machine-room-less elevator. However, the elevator could also be provided with a machine room located above the shaft 10 and the motor 14 could be arranged in the machine room.

The elevator further comprises guide rails 2, 12. Guide rails are supporting structures that run in the vertical direction in the elevator shaft 10. The guide rails 2, 12 guide the vertical movement of the elevator car 11 and the counterweight 17. Also, the safety gear of the elevator cooperates with the guide rails and the clamping jaws of the safety gear close around the guide and stop an overspeeding elevator car. The elevator of FIG. 1 comprises a pair of guide rails 2 that guide the counterweight 17 and another pair of guide rails 12 that guide the elevator car 11.

The guide rails 2, 12 have a T-shaped cross-sectional profile. Each guide rail 2, 12 is attached to the walls of the elevator shaft 10 via the arms of the T-shaped profile, while the side surfaces of the stem function as guide surfaces for the car 11 or the counterweight 17. The guide rails 2, 12 are assembled by connecting short segments to each other. The segments are hereinafter called as guide rail parts. Assembling of a guide rail 2, 12 typically starts from the bottom of the elevator shaft 10. The lowermost guide rail part is attached to the wall of the elevator shaft 10 and then the following guide rail part is attached to the lower guide rail part and to the wall of the shaft. The assembled guide rail section can be used as a support for a movable assembly platform, which can be moved upwards as the assembly work progresses.

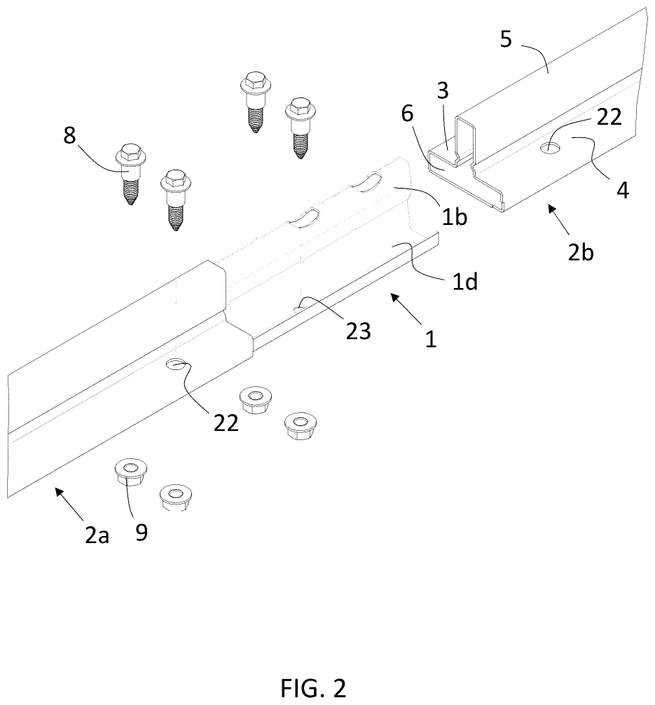

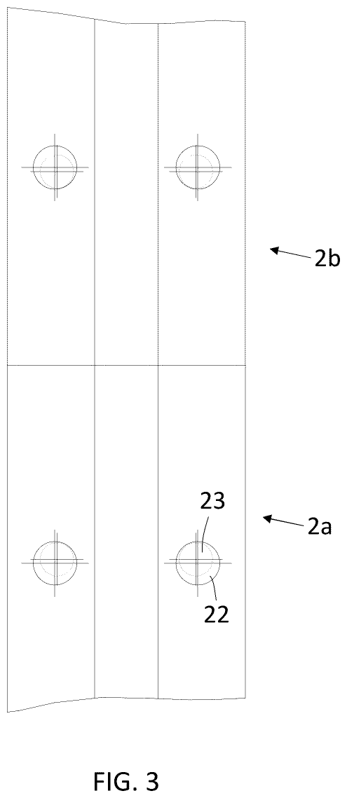

FIGS. 2-6 show different views of guide rail parts 2a, 2b. In the embodiments of the figures, the guide rail parts 2a, 2b are made of sheet metal, such as steel. Each guide rail part 2a, 2b has a T-shaped profile. The guide rail parts 2a, 2b are configured to be attached to the wall of the elevator shaft 10 via the arms 3, 4 of the profile. The side surfaces of the stem 5 of the profile function as guide surfaces for the counterweight 17 of the elevator. Also the top surface of the stem can function as a guide surface. The guide rail parts 2a, 2b are hollow and both ends of the guide rail part 2a, 2b are open. A cavity 6 is thus formed within the guide rail part 2a, 2b. The guide rail 2 is assembled using a plurality of identical or similar guide rail parts 2a, 2b. At the ends of the guide rail 2 the ends of the guide rail parts 2a, 2b could be closed. The stem 5 of the guide rail part 2a, 2b has a first side 5a, a second side 5b and a top 5c.

Two guide rail parts 2a, 2b are connected to each other using a connecting part 1. Part of a connecting part 1 according to an embodiment of the invention is shown in FIG. 2. The connecting part 1 has a first end and a second end. The first end of the connecting part 1 is configured to be inserted into a guide rail part 2a. The second end of the connecting part 1 is configured to be inserted into another guide rail part 2b. In a joint formed by the connecting part 1 and two guide rail parts 2a, 2b, the guide rail parts can be referred to as a first guide rail part 2a and a second guide rail part 2b. The connecting part 1 is made of sheet metal. Preferably, the connecting part 1 is made of the same material as the guide rail parts 2a, 2b. The connecting part 1 can thus be made of steel, such as zinc coated steel.

The connecting part 1 comprises a first stem portion 1a, which is configured to contact the first side 5a of the stem 5 of each of the guide rail parts 2a, 2b, and a second stem portion 1b, which is configured to contact the second side 5b of the stem 5 of each of the guide rail parts 2a, 2. The first stem portion 1a and the second stem portion 1b are connected to each other. The connecting part 1 is configured to contact the top 5c of the stem 5 of each of the guide rail parts 2a, 2b where the first and second stem portions 1a, 1b connect to each other. The connecting part 1 further comprises a first arm portion 1c configured to contact the first arm 3 of each of the guide rail parts 2a, 2b, and a second arm portion 1d configured to contact the second arm 4 of each of the guide rail parts 2a, 2b. The connecting part 1 can be made from a single piece of sheet metal.

Each arm portion 1c, 1d of the connecting part 1 is configured to be attached to the respective arm 3, 4 of the first guide rail part 2a and the second guide rail part 2b by means of at least one threaded fastening element 8 and a threaded counterpart 9 that is configured to be engaged with the threaded fastening element 8. In the embodiments of the figures, the threaded fastening element 8 is a bolt and the threaded counterpart 9 is a nut. However, the threaded fastening element 8 could also be a threaded rod, and nuts could be arranged at both ends of the threaded rod. Two threaded counterparts 9 could thus be engaged with each threaded fastening element 8. The threaded fastening element 8 is configured to be be inserted through the arm 3, 4 of the guide rail part 2a, 2b and through the arm portion 1c, 1d of the connecting part 1. The connecting part 1 is configured to deform as a result of the mutual tightening of the threaded fastening elements 8 and the respective threaded counterparts 9 and to exert a force on the inner surfaces of the guide rail parts 2a, 2b. When the nuts 9 or other threaded counterparts are tightened, the connecting part 1 deforms and aligns the first guide rail part 2a and the second guide rail part 2b with each other. The connecting part 1 is configured such that it can be inserted into the guide rail parts 2a, 2b without tools. The connecting part 1 is configured such that the force exerted on the inner surfaces of the guide rail parts 2a, 2b is relatively small to avoid substantial deformation of the guide rail parts 2a, 2b. In particular deformation of the stem 5, which forms guide surfaces for the counterweight 17 or the elevator car 11, should be avoided. The connecting part 1 thus deforms and aligns the guide rail parts 2a, 2b, but the guide rail parts 2a, 2b maintain their shape.

In the embodiments of the figures, the connecting part 1 is configured such that the deforming of the connecting part 1 exerts a force on the inner surfaces of the first and second sides 5a, 5b of the stems 5 of the guide rail parts 2a, 2b. The deforming of the connecting part 1 can further exert a force on the inner surfaces of the tops 5c of the stems 5 of the guide rail parts 2a, 2b. The connecting part 1 can be configured such that the deforming of the connecting part 1 exerts a force on the inner surfaces of the arms 3, 4 of the guide rail parts 2a, 2b on the sides that are opposite to the stems 5 of the guide rail parts 2a, 2b.

Each guide rail part 2a, 2b is provided with attachment holes 21, 22 arranged in the arms 3, 4 of the guide rail part 2a, 2b for receiving the threaded fastening elements 8. A first attachment hole 21 is arranged on the side opposite to the stem 5 of the guide rail part 2a, 2b and a second attachment hole 22 is arranged on the side of the stem 5. Apart from the guide rail parts 2a, 2b at the ends of the elevator shaft 10, each guide rail part 2a, 2b is attached to an adjacent guide rail part from each end. Both ends of the guide rail part 2a, 2b are thus provided with similar attachment holes 21, 22.

Each of the first arm portion 1c and the second arm portion 1d of the connecting part 1 is provided with an attachment hole 23 that is configured to be aligned with the first attachment hole 21 of the respective arm 3, 4 of the guide rail part 2a, 2b. The attachment hole 23 of the connecting part 1 has a smaller diameter than the first attachment hole 22 of the guide rail part 2a, 2b. In a non-mounted state of the connecting part 1, the distance between the attachment holes 23 of the first arm portion 1c and the second arm portion 1c can be shorter than the distance between the first attachments holes 21 of the first arm 3 and the second arm 4 of the guide rail part 2a, 2b. Mounting of the threaded fastening elements 8 can thus be configured to force the first and second arm portions 1c, 1d of the connecting part 1 away from each other, thus deforming the connecting part 1.

In the embodiments of the figures, each of the threaded fastening elements 8 has a tapered head. This facilitates inserting the threaded fastening elements 8 through the attachment holes 21, 22, 23, 24 of the guide rail parts 2a, 2b and the connecting part 1 and aligning of the respective attachment holes 21, 22, 23, 24.

The method according to the invention for assembling a hollow guide rail 2, 12 of an elevator comprises a step 101 of providing first and second guide rail parts 2a, 2b, a connecting part 1, threaded fastening elements 8 and threaded counterparts 9. A first end of the connecting part 1 is inserted into the first guide rail part 2a (step 102). The first guide rail part 2a can be attached to the elevator shaft 10 before the connecting part 1 is inserted into the first guide rail part 2. A second end of the connecting part 1 is engaged with the second guide rail part 2b (step 103). The first end of the connecting part 1 is attached to the first guide rail part 2a by means of the threaded fastening elements 8 and threaded counterparts 9 (step 104). The second guide rail part 2b is attached to the connecting part 1 by means of the threaded fastening elements 8 and threaded counterparts 9 (step 105). The steps of the method do not need to be carried out in the order described above. For instance, the connecting part 1 could be attached to the first guide rail part 2a by means of the threaded fastening elements 8 and counterparts 9 before the second guide rail part 2b is engaged with the connecting part 1. Alternatively, several guide rail parts 2a, 2b could be connected to each other by connecting parts 1 before using the threaded fastening elements 8 and counterparts 9 for attaching the guide rail parts 2a,2b to the connecting parts 1.

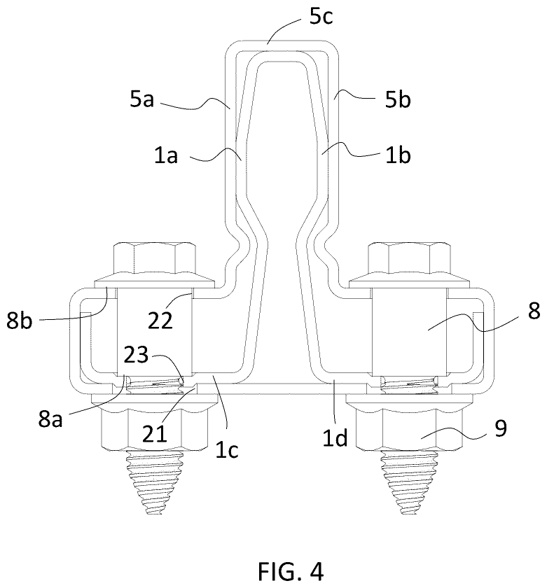

In the embodiment of FIG. 4, the connecting part 1 is an open profile. The first arm portion 1c and the second arm portion 1d are connected to each other only indirectly via the first and second stem portions 1a, 1b. The arm portions 1c, 1d contact the arms 3, 4 of the guide rail part 2a, 2b on the side opposite to the stem 5.

In the embodiment of FIG. 4, the threaded fastening element 8 is provided with a flange surface 8a that is configured to contact the connecting part 1 around the attachment hole 23 of the connecting part 1 when the counterpart 9 is tightened to deform the connecting part 1. The outer diameter of the flange surface 8a is larger than the diameter of the attachment hole 23 of the connecting part 1. The outer diameter of the flange surface 8a is smaller than the diameter of the second attachment hole 22 of the guide rail part 2a, 2b to allow the flange surface 8a to be inserted through the second attachment hole 22. Tightening of the threaded counterpart 9 pulls the flange surface 8a of the threaded fastening element 8 against the connecting part 1 around the attachment hole 23. Because the diameter of the first attachment hole 21 of the guide rail part 2a, 2b is larger than the diameter of the attachment hole 23 of the connecting part 1, the connecting part 1 can bend around the attachment hole 23. With a sufficient tightening force of the threaded counterpart 9, the connecting part 1 deforms plastically around the attachment hole 23 ensuring a very secure attachment of the connecting part 1 and the guide rail part 2a, 2b. One end of the threaded fastening element 8 is provided with a surface 8b supported against the outer surface of the respective arm 3, 4 of the guide rail part 2a, 2b.

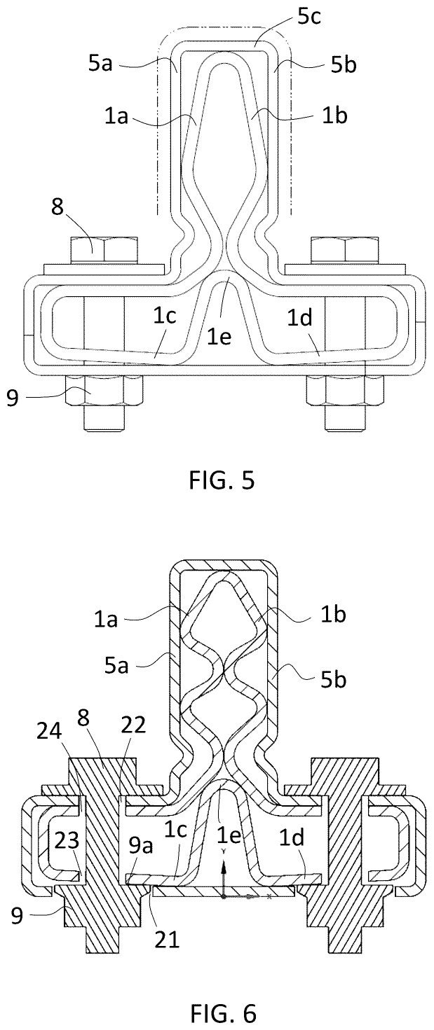

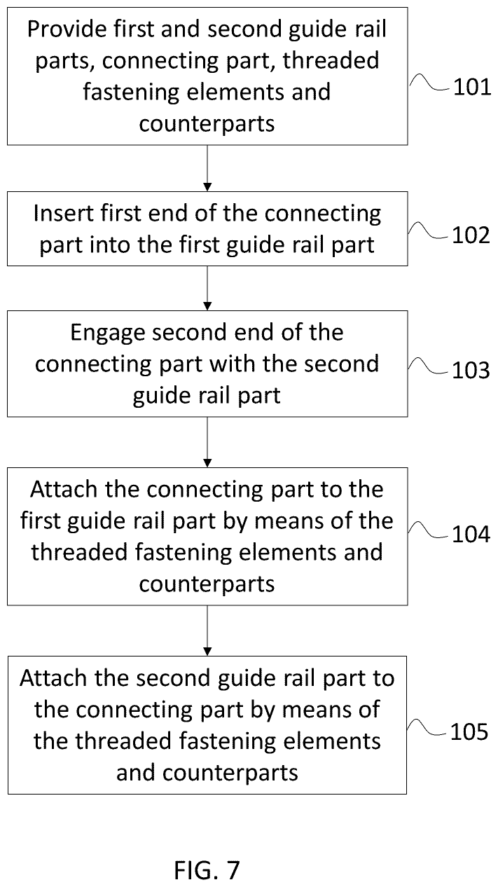

FIGS. 5 and 6 show other embodiments of the invention. In the embodiments of FIGS. 5 and 6, the outer diameter of the threaded counterpart 9 is smaller than the diameter of the first attachment hole 21 of the guide rail part 2a, 2b. The counterpart 9 is provided with a flange surface 9a that is configured to contact the connecting part 1 around the attachment hole 23 of the connecting part 1 when the counterpart 9 is tightened to deform the connecting part 1. In the embodiments of FIGS. 5 and 6, the connecting part 1 is deformed only elastically. The connecting part 1 is provided with a nose portion 1e that is arranged between the first and second arm portions 1c, 1d of the connecting part 1. The nose portion 1e is configured to push the first and second stem portions 1a, 1b of the connecting part 1 away from each other when the threaded counterpart 9 is tightened. A force is thus exerted on the inner surfaces of the first and second sides 5a, 5b of the stems 5 of the guide rail parts 2a, 2b. In the embodiments of FIGS. 5 and 6, the threaded fastening element 8 and the counterpart 9 could be arranged such that the connecting part 1 is contacted by a flange of the threaded fastening element 8. The embodiments of FIGS. 5 and 6 function in a similar way, but the stem portions 1a, 1b of the connecting part 1 are shaped differently. In the embodiment of FIG. 6, each stem portion 1a, 1b is configured to have two contact areas with the respective side of the stem 5 of the guide rail part 2a, 2b, whereas in the embodiment of FIG. 5, each stem portion 1a, 1b has only one contact area with the respective side of the stem 5.

In the embodiments of FIGS. 5 and 6, the connecting part 1 is a closed profile. Each arm portion 1c, 1d of the connecting part 1 is connected to the respective stem portion 1a, 1b of the connecting part 1. In addition, the arm portions 1c, 1d are connected to each other via the nose portion 1e. The arm portions 1c, 1d are configured to contact the inner sides of the respective arm 3, 4 of the guide rail part 2a, 2b both on the side of the stem 5 and on the side opposite to the stem 5. Each arm portion 1c, 1d of the connecting part 1 is provided with a second attachment hole 24, which is aligned in the mounted state of the connecting part 1 with the second attachment hole 22 of the guide rail part 2a, 2b.

The first and second guide rail parts 2a, 2b, the connecting part 1, the threaded fastening elements 8 and the threaded counterparts 9 form a guide rail assembly. A guide rail 2, 12 of an elevator can be made of a plurality of similar guide rail assemblies, where each guide rail part 2a, 2b forms part of two guide rail assemblies, apart from the guide rail parts 2a, 2b at the ends of the guide rail 2, 12.

In the embodiments of the figures, the connecting part 1 is attached to each arm 3, 4 of the two guide rail parts 2a, 2b by means of one threaded fastening element 8 and a respective counterpart 9. However, the connecting part 1 could be attached to each arm 3, 4 by means of two or more fastening elements 8.

It will be appreciated by a person skilled in the art that the invention is not limited to the embodiments described above, but may vary within the scope of the appended claims.

1. A connecting part for connecting a first guide rail part and a second guide rail part of a hollow guide rail of an elevator to each other, wherein each of said guide rail parts has a T-shaped cross-sectional profile comprising a stem, a first arm and a second arm,
wherein the connecting part is made of sheet metal and has a first end that is configured to be inserted into the first guide rail part and a second end that is configured to be inserted into the second guide rail part, and
wherein the connecting part comprises
a first stem portion configured to contact a first side of the stem of each of the guide rail parts,
a second stem portion configured to contact a second side of the stem of each of the guide rail parts,
a first arm portion configured to contact the first arm of each of the guide rail parts, and
a second arm portion configured to contact the second arm of each of the guide rail parts, and
wherein each arm portion of the connecting part is configured to be attached to the respective arm of the first guide rail part and the second guide rail part by means of at least one threaded fastening element that is configured to be inserted through the arm of the guide rail part and through the arm portion of the connecting part and by means of a threaded counterpart that is configured to be engaged with the threaded fastening element, and
wherein the connecting part is configured to deform as a result of the mutual tightening of said threaded fastening elements and the respective threaded counterparts and to exert a force on the inner surfaces of the guide rail parts.

2. A connecting part according to claim 1, wherein the connecting part is configured such that said deforming of the connecting part exerts a force on the inner surfaces of the first and second sides of the stems of the guide rail parts.

3. A connecting part according to claim 1, wherein the connecting part is configured such that said deforming of the connecting part exerts a force on the inner surfaces of the tops of the stems of the guide rail parts.

4. A connecting part according to claim 1, wherein the connecting part is configured such that said deforming of the connecting part exerts a force on the inner surfaces of the arms of the guide rail parts on the sides that are opposite to the stems of the guide rail parts.

5. A connecting part according to claim 1, wherein as a result of the mutual tightening of each threaded fastening element and the respective threaded counterpart, the connecting part is configured to deform plastically around said threaded fastening element.

6. A connecting part according to claim 1, wherein the connecting part is an open profile.

7. A connecting part according to claim 1, wherein the connecting part is made of steel.

8. A guide rail assembly for an elevator, the guide rail assembly comprising
a first guide rail part and a second guide rail part, each of the guide rail parts being hollow parts having a T-shaped cross-sectional profile comprising a stem, a first arm and a second arm;
a connecting part according to claim 1 inserted into the first guide rail part and into the second guide rail part;
at least one threaded fastening element inserted through each arm of each of the first guide rail part and the second guide rail part and through the respective arm portion of the connecting part; and
a threaded counterpart for each threaded fastening element, the threaded counterpart being engaged with the respective threaded fastening element and tightened to deform the connecting part.

9. A guide rail assembly according to claim 8, wherein each arm of each guide rail part is provided with a first attachment hole arranged on the side opposite to the stem of the guide rail part and with a second attachment hole arranged on the side of the stem for receiving said threaded fastening element, and each of the first arm portion and the second arm portion of the connecting part is provided with an attachment hole that is configured to be aligned with the first attachment hole of the respective arm of the guide rail part and has a smaller diameter than the first attachment hole, and the threaded fastening element or the counterpart is provided with a flange surface that is configured to contact the connecting part around said attachment hole of the connecting part when the counterpart is tightened to deform the connecting part.

10. A guide rail assembly according to claim 8, wherein each threaded fastening element has a tapered head.

11. An elevator comprising a guide rail assembly according to claim 8.

12. An elevator according to claim 11, wherein the guide rail assembly is part of a guide rail of a counterweight of the elevator.

13. A method for assembling a hollow guide rail of an elevator, wherein the method comprises the steps of
providing
a first guide rail part and a second guide rail part, each of the guide rail parts being a hollow part having a T-shaped cross-sectional profile comprising a stem, a first arm and a second arm,
a connecting part according to claim 1,
at least one threaded fastening element for each arm of each of the first guide rail part and the second guide rail part, configured to be inserted through the respective arm and through the respective arm portion of the connecting part, and
a threaded counterpart for each threaded fastening element, the threaded counterpart being configured to be engaged with the threaded fastening element and tightened to deform the connecting part;
inserting a first end of the connecting part into the first guide rail part;
engaging a second end of the connecting part with the second guide rail part; and
attaching the first end of the connecting part to the first guide rail part by means of said threaded fastening elements and threaded counterparts; and
attaching the second guide rail part to the connecting part by means of said threaded fastening elements and threaded counterparts.

14. A connecting part according to claim 2, wherein the connecting part is configured such that said deforming of the connecting part exerts a force on the inner surfaces of the tops of the stems of the guide rail parts.

15. A connecting part according to claim 2, wherein the connecting part is configured such that said deforming of the connecting part exerts a force on the inner surfaces of the arms of the guide rail parts on the sides that are opposite to the stems of the guide rail parts.

16. A connecting part according to claim 3, wherein the connecting part is configured such that said deforming of the connecting part exerts a force on the inner surfaces of the arms of the guide rail parts on the sides that are opposite to the stems of the guide rail parts.

17. A connecting part according to claim 2, wherein as a result of the mutual tightening of each threaded fastening element and the respective threaded counterpart, the connecting part is configured to deform plastically around said threaded fastening element.

18. A connecting part according to claim 3, wherein as a result of the mutual tightening of each threaded fastening element and the respective threaded counterpart, the connecting part is configured to deform plastically around said threaded fastening element.

19. A connecting part according to claim 4, wherein as a result of the mutual tightening of each threaded fastening element and the respective threaded counterpart, the connecting part is configured to deform plastically around said threaded fastening element.

20. A connecting part according to claim 2, wherein the connecting part is an open profile.
